(19) United States
(12) Patent Application Publication
(10) Pub. No.: US 2014/0237239 A1
(43) Pub. Date: Aug. 21, 2014

(54) TECHNIQUES FOR VALIDATING CRYPTOGRAPHIC APPLICATIONS

(71) Applicant: SafelyLocked, LLC, Atlanta, GA (US)

(72) Inventor: Harri Hursti, Atlanta, GA (US)

(21) Appl. No.: 14/143,248

(22) Filed: Dec. 30, 2013

Related U.S. Application Data
(60) Provisional application No. 61/747,478, filed on Dec. 31, 2012.

(51) Int. Cl. H04L 9/32

(52) U.S. Cl. CPC H04L 9/32; H04L 2209/04
USPC 713/168

(57) ABSTRACT

Disclosed are various embodiments for validating cryptographic applications. A cryptographic application is transmitted to a client device. Subsequently, a communication link is established with the transmitted cryptographic application as it executes in the client device. A round-trip time for communications with the transmitted cryptographic application is measured. Validation data and expected response data is generated, and the validation data is sent to the previously transmitted cryptographic application as it executes in the client device.

### CLAIM OF PRIORITY

This application claims priority to U.S. Provisional Application Ser. No. 61/747,478, filed on Dec. 31, 2012, which is incorporated by reference in its entirety as if fully set forth herein.

### BACKGROUND

In an age of information, people may produce substantial quantities of data. Those originating the data may wish to keep some of the data confidential as to the general public, while also sharing the data with select recipients. Traditional data security architectures suffer from vulnerabilities that may compromise the confidence of the data as it is stored and as it traverses networks such as the Internet.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a flowchart illustrating one example of functionality implemented as portions of a dispatch service executed in a computing environment in the networked environment of FIG. 1 according to various embodiments of the present disclosure.

FIG. 3 is a flowchart illustrating one example of functionality implemented as portions of a dispatch service executed in the computing environment in the networked environment of FIG. 1 according to various embodiments of the present disclosure.

FIG. 4 is a schematic block diagram that provides one example illustration of a client device employed in the networked environment of FIG. 1 according to various embodiments of the present disclosure.

### DETAILED DESCRIPTION

Disclosed are various techniques for the secure encryption, storage, distribution, and decryption of data for an end-user. According to various embodiments, a cryptographic application may be obtained for validation and execution in a client device. The cryptographic application may offer various services, including encrypting plaintext data available to the client device. In response to an encryption request, the cryptographic application may generate a ciphertext key with which to configure the encryption algorithm. The cryptographic application implementing the encryption algorithm may produce ciphertext data as output based upon the plaintext data as input. The cryptographic application may also encrypt the ciphertext key within a recipient wrapper, where an encryption algorithm is configured with a recipient key that may be unique for each recipient. The ciphertext data and the recipient wrapper may then be transmitted via a network to one or more remote computing devices for later retrieval.

A recipient may access the particular ciphertext data shared with him or her through use of an identifier, such as a uniform resource identifier (URI), which may initiate on-demand retrieval and/or execution of the cryptographic application in the client device. The cryptographic application may retrieve the ciphertext data and the recipient wrapper from the remote computing device(s). The recipient may apply the appropriate key to the cryptographic application in order to decrypt the ciphertext key from the recipient wrapper. Thereafter, the cryptographic application may decrypt the ciphertext data using the ciphertext key. In the following discussion, a general description of the system and its components is provided, followed by a discussion of the operation of the same.

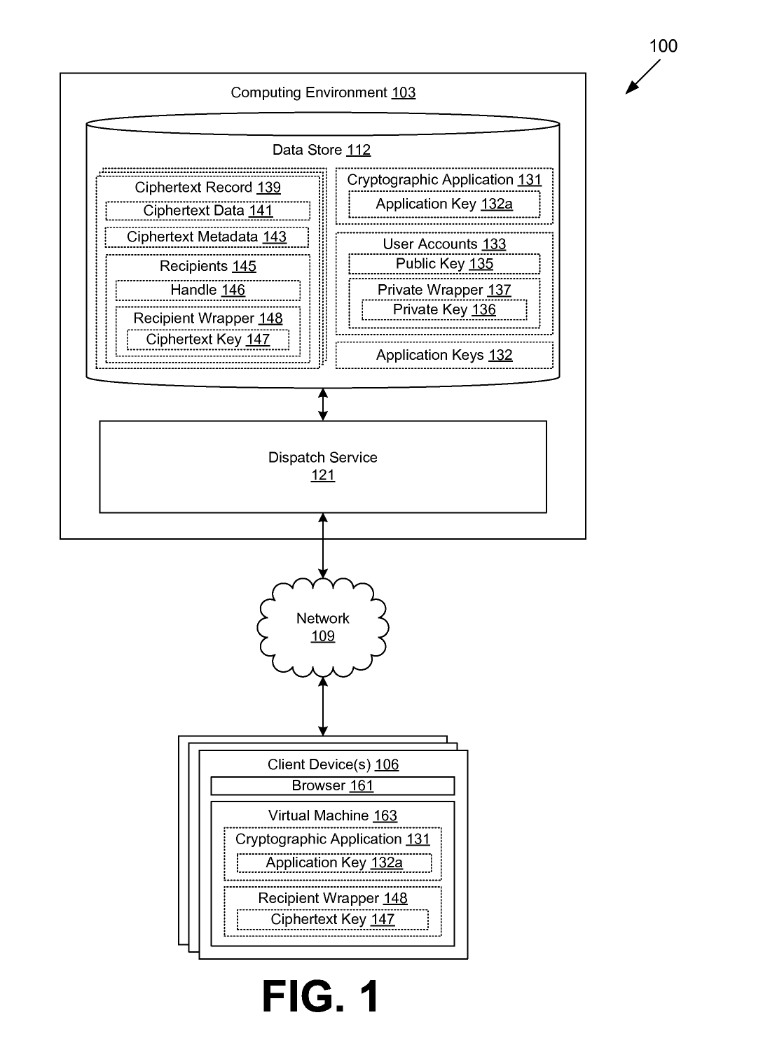

With reference to FIG. 1, shown is a networked environment 100 according to various embodiments. The networked environment 100 includes a computing environment 103 and a client device 106, which are in data communication with each other via a network 109. The network 109 includes, for example, the Internet, intranets, extranets, wide area networks (WANs), local area networks (LANs), wired networks, wireless networks, or other suitable networks, etc., or any combination of two or more such networks.

The computing environment 103 may comprise, for example, a server computer or any other system providing computing capability. Alternatively, the computing environment 103 may employ a plurality of computing devices that may be employed that are arranged, for example, in one or more server banks or computer banks or other arrangements. Such computing devices may be located in a single installation or may be distributed among many different geographical locations. For example, the computing environment 103 may include a plurality of computing devices that together may comprise a cloud computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include a dispatch service 121 and other applications, services, processes, systems, engines, or functionality not discussed in detail herein. The dispatch service 121 is executed in order to facilitate the secure exchange of data among various client devices 106. To that end, the dispatch service 121 also performs various backend functions associated with management and distribution of ciphertext data and associated cryptographic materials to the client devices 106 over the network 109. For example, the dispatch service 121 generates content pages such as, for example, web pages, multimedia messaging service (MMS) messages, and/or other types of network content that are provided to clients 106 for the purposes of facilitating secure storage and/or retrieval of data.

The data stored in the data store 112 includes, for example, a cryptographic application 131, application keys 132, user accounts 133, ciphertext records 139, and potentially other data. The cryptographic application 131 may be representative of a plurality of cryptographic applications 131 as can be appreciated. The cryptographic application 131 may be executable in the client device 106 to facilitate cryptographic services such as key generation, encryption, decryption, integrity checking, and/or other possible operations as can be appreciated. The cryptographic application 131 may implement various cryptographic algorithms necessary for these aforementioned services such as, for example, the data encryption standard (DES) algorithm, the advanced encryption standard (AES) algorithm, the triple data encryption standard (3-DES) algorithm, the Rivest, Shamir, Adelman (RSA) algorithm, the Twofish algorithm, the Threefish algorithm, the Blowfish algorithm, the Serpent algorithm, elliptic curve cryptography (ECC), various versions of the secure hash algorithm (SHA), the Skein hash algorithm, and/or other algorithms as can be appreciated.

The cryptographic application 131 may be directly executable by a processor of the client device 106 or by a virtual machine (e.g. Java®, JavaScript®, etc.) executing in the client device 106. In some embodiments, the cryptographic application 131 may include the ability to confirm the data integrity of the cryptographic application 131 using techniques such as a digital signature, challenge-response handshake, client-side key verification, and/or other possible techniques. The application keys 132 may be representative of one or more cryptographic keys that may be associated with various instances of the cryptographic applications 131. In some embodiments, one or more of the application keys 132 may be usable to further validate a cryptographic application 131 executing in a client device 106 as will be described.

Each of the user accounts 133 may include information about a registered user of the dispatch service 121, such as, for example, name, address, email addresses, payment instruments, billing information, account settings, authentication credentials, user group membership, file management permissions, storage quotas and limitations, and/or other data. In some embodiments, the user accounts 133 may further include a public/private key pair comprising a public key 135 and a private key 136. The public/private key pair may be produced for use by implementations of RSA, ElGamal, ECC, Elliptic Curve Diffie-Helman (“ECDH”) algorithm, or other asymmetric key (“public key”) cryptography algorithms.

As the name suggests, the public key 135 may be publicly accessible to other users of the dispatch service 121, including users with and without a user account 133. The private key 136 may be protected by a cryptographic private wrapper 137. The private wrapper 137 may be generated according to AES key wrap specification, TDKW, PSEC-KEM, public key cryptography standards (PKCS), and/or other key wrap specifications as can be appreciated.

Each of the ciphertext records 139 include various data associated with ciphertext data provided by the client devices 106. The data included in each ciphertext record 139 may include ciphertext data 141, ciphertext metadata 143, recipients 145, and/or other data associated with the cryptographic transformation of plaintext data obtained from the client 106.

The ciphertext data 141 includes the ciphertext produced from the plaintext by the cryptographic application 131 executing in the client device 106. In some embodiments, the ciphertext data 141 may include one or more pointers to other locations where the actual ciphertext is stored in segments or in the entirety. The ciphertext metadata 143 may include various metadata associated with the ciphertext data 141 such as, for example, one or more cryptographic hash values, the cryptographic algorithms used, access permissions, ownership identifiers, originator identifiers, and/or other possible metadata.

The recipients 145 of each ciphertext record 139 include the various parties for whom access to the ciphertext data 141 has been granted. Each of the recipients 145 may include a handle 146, a ciphertext key 147 secured by a recipient wrapper 148, and potentially other data. The handle 146 may include one or more identifiers through which the recipient 145 may access the ciphertext data 141. For example, the handle 146 may include a URI, uniform resource locator (URL), global unique identifier (GUID), and/or other types of identifiers as can be appreciated.

The ciphertext key 147 is the one or more keys used to configure the corresponding cryptographic application 131 used to generate the ciphertext data 141 associated with the given ciphertext record 139. The recipient wrapper 148 may be a cryptographic wrapper generated according to AES key wrap specification, TDKW, PSEC-KEM, public key cryptography standards (PKCS), and/or other key wrap specifications as can be appreciated. The ciphertext key 147 may be identical for all recipients 145 of a given ciphertext record 139, while the recipient wrapper 148 may be unique for each recipient 145. Each of the recipients 145 may further include a log providing a history of access or attempts to access the ciphertext data 141, handle 146, ciphertext key 147, and/or other possible data.

Additionally, the data store may include one or more virtual file systems (VFS). The virtual file systems (VFS) may include various data associated with users or groups of users creating virtual file systems that use the ciphertext data 141 of one or more ciphertext records 139 for actual data storage. The virtual file system service may be implemented using the file system in userspace (FUSE) driver or other virtual file system driver as can be appreciated. The virtual file systems may further store the ciphertext metadata 143 associated with files stored in the virtual file systems which have been created. Audit records of the data store 112 may include a log of various activities undertaken with regard to the ciphertext records 139, contents of the virtual file systems, validation and execution of the cryptographic application 131 in the client device 106, and/or other interactions of the cryptographic application 131 with the dispatch service 121.

In some embodiments, the ciphertext metadata 143 stored in the virtual file systems may correspond to a master record and be encrypted by the ciphertext key 147. In such embodiments, a relational table may be associated with the master record in order to track file versions and/or file histories. File history records stored in the relational table may be separately encrypted with their own corresponding keys, permitting both encrypted metadata and searchable metadata to remain separate from individual file versions. Such embodiments allow multiple versions, such as multiple historical versions or other versions, of a file to be maintained in association with the master record.

The client 106 is representative of a plurality of client devices that may be coupled to the network 109. The client 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability.

The client 106 may be configured to execute various applications such as a browser 161, virtual machine 163, and/or other applications, services, processes, systems, engines, or functionality not discussed in detail herein. The browser 161 may be executed in a client 106, for example, to initiate the cryptographic services offered by the computing environment 103 and/or other servers. The virtual machine 163 is a software implementation of a computer that is capable of executing the cryptographic application 131 and potentially other applications as would a physical computing device. Various virtual machines may be available on the client 106 including, for example, Java®, JavaScript®, Python, and/or other virtual machines as can be appreciated. In some embodiments, the virtual machine 163 may be integrated within the browser 161.

Next, a general description of the operation of the various components of the networked environment 100 is provided. To begin, an extended validation mechanism may be desirable for cryptographic applications 131 executing in various client devices 106. In various embodiments, the extended validation may be carried out through the use of one or more application keys 132 that may be embedded within a given cryptographic application 131, shown as application key 132a. Each of the application keys 132 stored in the data store 112 and/or embedded within the cryptographic applications 131 may usable to configure cryptographic algorithms which may be implemented in a cryptographic application 131. The application keys 132 may be generated using a pseudorandom number generator (PRNG) or other sources of key entropy.

In some embodiments, the application key 132a may not be stored as a constant value in the cryptographic application 131, but rather may be represented by a function or other programmatic code that may be used to produce the value of the application key 132a. As a non-limiting example, each instance of a cryptographic application 131 may contain a unique application identifier. Rather than storing the constant value of the application key 132a in the corresponding cryptographic application 131, a function may be stored that produces the value of the application key 132a when the corresponding unique application identifier is used as input.

Regardless of the operation used to embed a selected application key 132a within a given instance of the cryptographic application 131, the instance of the cryptographic application 131, along with the embedded application key 132a may be stored in the data store 112. Furthermore, an identifier of the instance of the cryptographic application 131, as well as the value of the application key 132a embedded within, may be stored as metadata within the application keys 132 or elsewhere within the data store 112. Thereafter, the instance of the cryptographic application 131 may be available for delivery to a client 106.

Subsequently, a client 106 may possess data to be encrypted and securely stored. To that end, the client 106 may establish a communication session with the computing environment 103 using the browser 161 or other client application. In some embodiments, the computing environment 103 may supply one or more session credentials with which the client device 106 may authenticate the computing environment 103. The session credentials supplied by the computing environment 103 may include a digital certificate, a shared secret key, client-side key verification, and/or other possible credentials as can be appreciated.

In addition to authentication, the session credentials may be used to facilitate encryption of the communication session, thereby providing some degree of both authentication and confidentiality of the data as it is exchanged between the computing environment 103 and client 106. Establishing a communication session may occur as part of a secure socket layer/transport layer security (SSL/TLS) negotiation. Furthermore, in some embodiments, the client 106 may also provide one or more session credentials with which the computing environment 103 may authenticate the client device 106, therein providing mutual authentication. It should be noted that any credentials exchanged during establishment of the communication session may be independent of the credentials employed for later use in the generation of ciphertext data 141. Once the communication session is established, the dispatch service 121 may transmit an instance of the cryptographic application 131 for execution in the client 106.

In various embodiments, the cryptographic application 131 executing in the client 106 may include an embedded application key 132a with which an extended validation of the cryptographic application 131 may be performed. The extended validation may begin with the dispatch service 121 estimating the round-trip time for communication between the computing environment 103 and the client 106. The measurement of the round-trip time may occur during the previously described authentication phase or may be a separate communication between the computing environment 103 and the client 106. Additionally, the instance of cryptographic application 131 executing in the client may extract the embedded application key 132a. As previously described, in some embodiments, the application key 132a may need to first be derived through use of a function or other programmatic code of the instance the cryptographic application 131.

In order to employ the application key 132a to perform the extended validation, the dispatch service 121 may transmit data for validation (“validation data”) to the cryptographic application 131 executing in the client 106. The validation data transmitted may be recognized by the executing cryptographic application 131 as initiation of an extended validation. Thus, the cryptographic application may proceed to perform the pre-programmed validation routines upon the validation data, with which a response may be generated for the dispatch service 121.

As a non-limiting example, the data transmitted by the dispatch service 121 may include two different strings: a first string that is encrypted and the second string having no encryption applied. A valid cryptographic application 131 may be programmed to use the application key 132a to both decrypt the first string and to encrypt the second string, then transmit the two strings back to the dispatch service in a response. If the dispatch service 121 receives the response having the expected form, the dispatch service may examine the two strings in the response. If the cryptographic application 131 of the client 106 is valid and configured with the correct application key 132a, the data of the two strings will be as expected by the dispatch service 121. The dispatch service 121 formulates the expectation based on the known operations to be performed by a valid cryptographic application 131 and the known application key 132a embedded within the particular instance of the cryptographic application 131. In the case that the response is as expected from the cryptographic application 131, the dispatch service 121 may transmit a confirmation message to the cryptographic application 131 or, alternatively, no express approval may be sent.

Continuing the example, in the case that a response is not received from the client 106 within the expected round-trip time plus an acceptable delay tolerance, the dispatch service may re-initiate the extended validation operation using a different cryptographic application 131 having a different application key 132a. For example, if the response is received earlier than the estimated round-trip time plus an acceptable tolerance, it may indicate that the connection between the client 106 and the computing environment 103 is subject to tampering, such as by a third party performing a man-in-the-middle attack. As another example, if the response is received later than the estimated round-trip time plus an acceptable tolerance, it may indicate that a timeout, such as one due to packet loss, has occurred. Further, if a response is received by the dispatch service 121 and the form of the response and/or the two strings received in the response are not as expected, the dispatch service 121 may transmit a terminate instruction to the cryptographic application 131. In the event that no response is received or an improper response is received, the dispatch service 121 may report the incident to a user, as well as log the incident within an audit log of the data store 112.

Upon establishing a communication session with the computing environment 103, the client 106 may provide the dispatch service 121 with a service request to encrypt data available to the client 106. The data to be encrypted may be referred to as “plaintext” data throughout the present disclosure. However, as one skilled in the art may appreciate, use of the term “plaintext” does not require the data to be in a text format (e.g. American standard code for information interchange (ASCII), Unicode, etc.), nor does it suggest the data has no other encryption presently applied. A unit of data may simply be referred to as plaintext if it is in a non-encrypted state relative to a pending cryptographic operation.

In response to the service request, the dispatch service may deliver the cryptographic application 131 via the network 109. In response to obtaining the cryptographic application 131 through the browser 161 or other client application, execution of the cryptographic application 131 within a virtual machine 163 may be initiated in the client 106. In some embodiments, the cryptographic application 131 may include the ability to confirm the data integrity of the cryptographic application 131 as it executes in the client 106 using techniques such as a digital signature, challenge-response handshake, client-side key verification, and/or other possible techniques as can be appreciated.

A user of the client 106 may interact with the cryptographic application 131 executing in the client 106 to initiate the encryption and storage operation. The cryptographic application 131 may begin by creating a cryptographically strong ciphertext key 147 suitable for use by the encryption algorithm implemented in the cryptographic application 131. A strong ciphertext key 147 may be created using various sources of key entropy such as, for example, access time for a storage device, differences in the timing of the cores of a processor in the client 106, cryptographic-assistive hardware available to the client 106, and/or other possible sources. Thereafter, the requested encryption operation may be carried out by the cryptographic application 131 implementing one or more encryption algorithms configured with the ciphertext key 147. The product of the encryption operation is the ciphertext data 141.

In some embodiments, the cryptographic application 131 may calculate a cryptographic hash of the plaintext data prior to encryption. In various embodiments, the cryptographic hash value may be generated using a secret key associated with the computing environment 103, thereby creating a hash-based message authentication code (HMAC). In other embodiments, the cryptographic hash value may be signed using with a private key of an asymmetric key pair, as is performed by implementations of the digital signature algorithm (DSA) or other possible algorithms providing digital signatures. Similarly, a cryptographic hash value of the ciphertext data 141 may also be produced. In some embodiments, the ciphertext data 141 may be divided into discrete segments from which the entire ciphertext data 141 may be reconstituted. In these embodiments, a cryptographic hash value may also be calculated for each individual segment of the ciphertext data 141.

The ciphertext data 141 produced by the cryptographic application 131 may be transmitted to the computing environment 103 for storage in a unique ciphertext record 139 of the data store 112. Additionally, the one or more cryptographic hashes computed on the plaintext data and the ciphertext data 141, including segments of the ciphertext data 141, may be placed in the ciphertext metadata 143 of the ciphertext record 139.

As described previously, the computing environment 103 may employ a plurality of computing devices. In light of this configuration, the ciphertext data 141, and/or segments thereof, may be stored in one or more computing devices of the computing environment 103. To affect the transfer of the ciphertext data 141 to the computing environment 103, the client device 106 may initiate one or more data transfer sessions to the computing environment 103 and/or the constituent computing devices of the computing environment 103. Throughout this disclosure, references of data transfer between the client 106 and the computing environment 103 should be understood to occur in light of various possible configurations. Furthermore, the data transfer may be undertaken using hypertext transfer protocol (HTTP), HTTP secure (HTTPS), file transfer protocol (FTP), trivial FTP (TFTP), file service protocol (FSP), and/or other data transfer protocols, either connection-oriented or connectionless, as can be appreciated.

Independent of the transfer of the ciphertext data 141 to the data store 112, the cryptographic application 131 may encrypt the ciphertext key 147 with a recipient wrapper 148. The recipient wrapper 148 may be generated according to AES key wrap specification, TDKW, PSEC-KEM, public key cryptography standards (PKCS), and/or other key wrap specifications as can be appreciated. The recipient key used to generate the recipient wrapper 148 may be a shared secret, such as a passphrase, commonly known graphical shape, or a public key 135 associated with a user account 133 of the recipient.

This process may be repeated for each intended recipient for a given ciphertext data 141 resulting in identical copies of the ciphertext key 147 encrypted with recipient wrappers 148 that are unique to each recipient. Thereafter, each recipient wrapper 148, including the ciphertext key 147, may be transferred to the computing environment 103 for placement in a unique record for each recipient 145 of the ciphertext data 141. Furthermore, the dispatch service may generate a unique handle 146 through which each recipient 145 may access the ciphertext data 141 and their unique recipient wrapper 148. Once the encryption and storage operations requested by the user of the client 106 are complete, this portion of the cryptographic application 131 executing in the virtual machine 163 may terminate. In some embodiments, the cryptographic application 131 may overwrite and/or “zero-ize” any portions of residual data from operations of the cryptographic application 131 that may remain on the client device 106.

The dispatch service 121 may notify the various recipients 145 of the availability of data shared with them by an originator of the data. The notification may be sent to an email address, instant message, short message service (SMS), MMS, and/or other methods of contact specified by the originator or included in user account 133 of a recipient. The notice sent to the contact address for each recipient 145 may include the handle 146 associated with the respective recipient 145. For example, the handle 146 may be a unique URI, wherein a user of a client 106 following the URI may initiate a communication session with the computing environment 103 using the browser 161 or other client application. As described previously, the client 106 may exchange various credentials with the computing environment in order to establish the communication session.

The handle 146 may serve as an embedded service request instructing the dispatch service that the client 106 requests access to particular ciphertext data 141 and recipient wrapper 148 associated with the recipient 145 for whom the handle 146 was created. In response to the service request, the dispatch service 121 may deliver the cryptographic application 131 via the network 109. In response to obtaining the cryptographic application 131 through the browser 161 or other client application, execution of the cryptographic application 131 within a virtual machine 163 may be initiated in the client 106.

In some embodiments, the ciphertext data 141 of one or more ciphertext records 139 may be shared among a group of users. In these embodiments, the cryptographic application 131 for the user creating the group may create a public/private key pair for the group, in addition to other keys that may be created for a ciphertext record 139 as described previously. In various embodiments, the group public/private key pair may be associated with a virtual file system or other type of virtual workspace that may be associated with one or more one or more ciphertext records 139. In these embodiments, the group public/private key pair for a virtual file system may resemble a public/private key pair for a user account 133, and therefore may be considered a “virtual user.”

The group public/private key pair may be produced by implementations of RSA, ElGamal, ECC, ECDH, or other asymmetric key (“public key”) cryptography algorithms. The ciphertext key 147 may be encrypted using the group public key, resulting in a group wrapper for the ciphertext key 147. The group wrapper may be generated according to PSEC-KEM, public key cryptography standards (PKCS), and/or other asymmetric key wrap specifications as can be appreciated. The group wrapper, including the ciphertext key 147, may be stored in the ciphertext metadata 143 for the ciphertext record 139 and/or elsewhere within the data store 112 of the computing environment 103.

In these embodiments, the cryptographic application 131 may also encrypt the group private key with a recipient wrapper 148. The recipient wrapper 148 may be generated according to AES key wrap specification, TDKW, PSEC-KEM, public key cryptography standards (PKCS), and/or other key wrap specifications as can be appreciated. The recipient key used to generate the recipient wrapper 148 may be a shared secret, such as a passphrase, a commonly known graphical shape, or a public key 135 associated with a user account 133 of the recipient. This process may be repeated for each intended recipient (i.e. each group member) for a given ciphertext data 141, resulting in identical copies of the group private key encrypted with recipient wrappers 148 that are unique to each recipient. Thereafter, each recipient wrapper 148, including the group private key, may be transferred to the computing environment 103 for placement in a unique record for each recipient 145 of the ciphertext data 141.

A user of the client 106 may interact with the cryptographic application 131 executing in the client 106 to attempt a decryption and storage operation. The cryptographic application 131 may begin by obtaining both the ciphertext data 141 and recipient wrapper 148, embedded with the encrypted ciphertext key 147. In some embodiments, the ciphertext data 141 may be compared to one or more associated cryptographic hash values from the ciphertext metadata 143 in order to validate the data integrity of the ciphertext data 141 as received.

The recipient user may provide the cryptographic application 131 with their unique recipient key with which the ciphertext key 147 may be decrypted. As discussed previously, the ciphertext key 147 may have been encrypted in the unique recipient wrapper 148 using a passphrase or the public key 135 associated with a user account 133 of the recipient user. In some embodiments, a key stretching and/or strengthening algorithm, such as the Password-Based Key Derivation Function 2 (PBKDF2), the bcrypt algorithm, the scrypt algorithm, and/or other such algorithms or approaches, may be used in conjunction with the passphrase to produce the unique recipient wrapper 148. In other embodiments, the ciphertext key 147 may have been encrypted in the unique recipient wrapper 148 using a graphical shape drawn by a user. In such embodiments, the graphical shape may be converted to a series of bits or bytes analogous to a passphrase, which may be used in conjunction with key stretching and/or strengthening algorithms such as PBKDF2, the bcrypt algorithm, the scrypt algorithm, and/or other such algorithms to encrypt the ciphertext key 147 in the unique recipient wrapper 148. As an illustrative and non-limiting example, the graphical shape may be used as an input to a hash algorithm and/or a key stretching and/or strengthening algorithm to generate a key with an appropriate length and/or entropy to encrypt the ciphertext key 147 in the unique recipient wrapper 148. In some embodiments, additional information associated with the inputting of the graphical shape may be used as part of the input to the hash algorithm and/or the key stretching and/or strengthening algorithm. For example, the speed at which the graphical shape is drawn, pauses in drawing the graphical shape, and other information associated with inputting the graphical shape, may be used as part of the input to the hash algorithm and/or the key stretching and/or strengthening algorithm.

Further, such embodiments may combine the user of the passphrase and the graphical shape, as described above, to encrypt the ciphertext key 147 in the unique recipient wrapper 148. For example, the series of bits or bytes representing the passphrase and the graphical shape may be combined into a single input for a hash algorithm and/or a key stretching and/or strengthening algorithm to generate a key with an appropriate length and/or entropy to encrypt the ciphertext key 147 in the unique recipient wrapper 148. In such embodiments, the passphrase and the graphical shape may be concatenated together. In other embodiments, bits or bytes of the passphrase may be interspersed among the bits or bytes of the graphical shape or vice versa. In other embodiments, a first round of encryption of the ciphertext key 147 using the passphrase and a second round of encryption of the ciphertext key 147 using the graphical shape, or vice versa, may be performed to encrypt the ciphertext key 147 in the unique recipient wrapper 148.

Therefore, in order to decrypt the ciphertext key 147, the recipient user must enter the complementary credential used to perform the encryption. If a passphrase were used to generate the recipient wrapper 148 by the originating user, the same passphrase must be entered into the cryptographic application 131 by the recipient user. If a graphical shape were used to generate the recipient wrapper 148 by the originating user, the same graphical shape must be drawn by the recipient user and submitted to the cryptographic application 131 by the recipient user.

Alternatively, if the originating user generated the recipient wrapper 148 using the public key 135 of the recipient user, the associated private key 136 must be used to decrypt the ciphertext key 147. In order for the recipient user to employ their own private key 136, it must first be decrypted from the private wrapper 137. Prior to performing the decryption of the private key 136, the private wrapper 137, including the encrypted private key 136, is obtained from the computing environment 103 by the cryptographic application 131. The recipient user supplies their personal passphrase or other user credential to decrypt their private key 136 from the private wrapper 137 within the context of the cryptographic application 131. Once the private key 136 is available, it may be applied to the cryptographic application 131 in order to decrypt the ciphertext key 147 from the recipient wrapper 148.

In some embodiments, the ciphertext record 139 accessed by the cryptographic application 131 may be shared by a group of users and may further be one of potentially many objects of a VFS or other virtual workspace. In these embodiments, the recipient wrapper 148 may not include the ciphertext key 147, but instead a group private key. However, the same operations previously described with extracting a key from a recipient wrapper 148 may be applied whether the extracted key is a ciphertext key 147 or a group private key. Once the group private key is extracted from the recipient wrapper 148, the cryptographic application 131 may also obtain the group wrapper from the ciphertext metadata 143 or elsewhere within the data store 112. In these embodiments, the ciphertext key 147 may be decrypted from within the group wrapper using the group private key extracted from the recipient wrapper 148.

Regardless of the method used to encrypt the ciphertext key 147, once it is obtained, the ciphertext key 147 may be applied to the cryptographic application 131 in order to decrypt the plaintext data from the ciphertext data 141 provided by the originating user. In some embodiments, the plaintext data may be compared to one or more associated cryptographic hash values, including any HMAC, from the ciphertext metadata 143 in order to validate the data integrity of the plaintext data. The validation may confirm that the plaintext data as decrypted by the cryptographic application 131 of the recipient user is the same as the plaintext data as encrypted by the cryptographic application 131 of the originating user.

In embodiments in which a ciphertext record 139 may be shared by a group of users, a member of the group may access and modify the ciphertext data 141 of the ciphertext record 139. In these embodiments, the ciphertext data 141 may be decrypted using the cryptographic application 131 as previously described. Thereafter, if modifications were made to the plaintext form of the ciphertext data 141, the modified version of the plaintext data may be encrypted and stored as ciphertext data 141 in the ciphertext record 139. In various embodiments, a new ciphertext key 147 may be generated and used to encrypt the modified plaintext data. The new ciphertext key 147 for the ciphertext data 141 may then be encrypted using the group public key, resulting in a new group wrapper for the new ciphertext key 147.

As discussed previously, the dispatch service 121 may further log various data associated with access or attempted access of the handle 146 and recipient wrapper 148 within a record associated with each recipient 145 and/or in the audit records. Similarly, the cryptographic application 131 may notify the dispatch service 121 of the state of various events associated with attempts to decrypt the ciphertext data 141 such as, for example, mismatched cryptographic hash values, matching cryptographic hash values, incorrect recipient keys entered, and/or other possible events as can be appreciated. Such a history of interactions for a given recipient user associated with a recipient 145 may be used to offer and enforce services associated with recipient access such as a maximum number of failed decryption attempts, a maximum number of successful decryption attempts, and/or other services as can be appreciated.

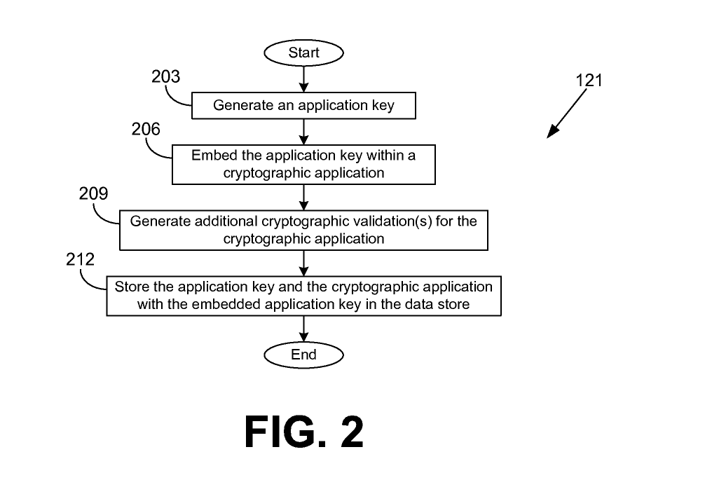

Referring next to FIG. 2, shown is a flowchart that provides one example of the operation of a portion of the dispatch service 121 according to various embodiments. It is understood that the flowchart of FIG. 2 provides merely an example of the many different types of functional arrangements that may be employed to implement the operation of the portion of the dispatch service 121 as described herein. As an alternative, the flowchart of FIG. 2 may be viewed as depicting an example of steps of a method implemented in the computing environment 103 (FIG. 1) according to one or more embodiments.

This portion of the execution of the cryptographic application 131 may be executed in order to embed the application key 132a (FIG. 1) within an instance of the cryptographic application 131 (FIG. 1) to be stored for later execution in a client 106 (FIG. 1). Beginning with block 203, the dispatch service 121 may generate one or more application keys 132 using a pseudorandom number generator (PRNG) or other sources of key entropy. Next, in block 206, the dispatch service 121 may select one or more application keys 132 to be embedded within a given instance of a cryptographic application 131, shown as application key 132a. As described previously, in some embodiments, the application key 132a may not be stored as a constant value, but rather may be represented by a function or other programmatic code that may be used to produce the application key 132a. Additionally, the dispatch service 121 may obfuscate all or portion of the code of the cryptographic application 131 using various possible code obfuscation operations as can be appreciated.

Then, in block 209, the dispatch service may employ other validation techniques for the cryptographic application 131 such as a digital signature, client-side key verification, and/or other possible techniques as can be appreciated. Subsequently, in block 212, the dispatch service 121 may store the instance of the cryptographic application 131, along with the embedded application key 132a, in the data store 112. Additionally, the dispatch service 121 may store the value of the application key 132a and an identifier for the particular instance of the cryptographic application 131 in the data store 112. Thereafter, this portion of the execution of the dispatch service ends as shown.

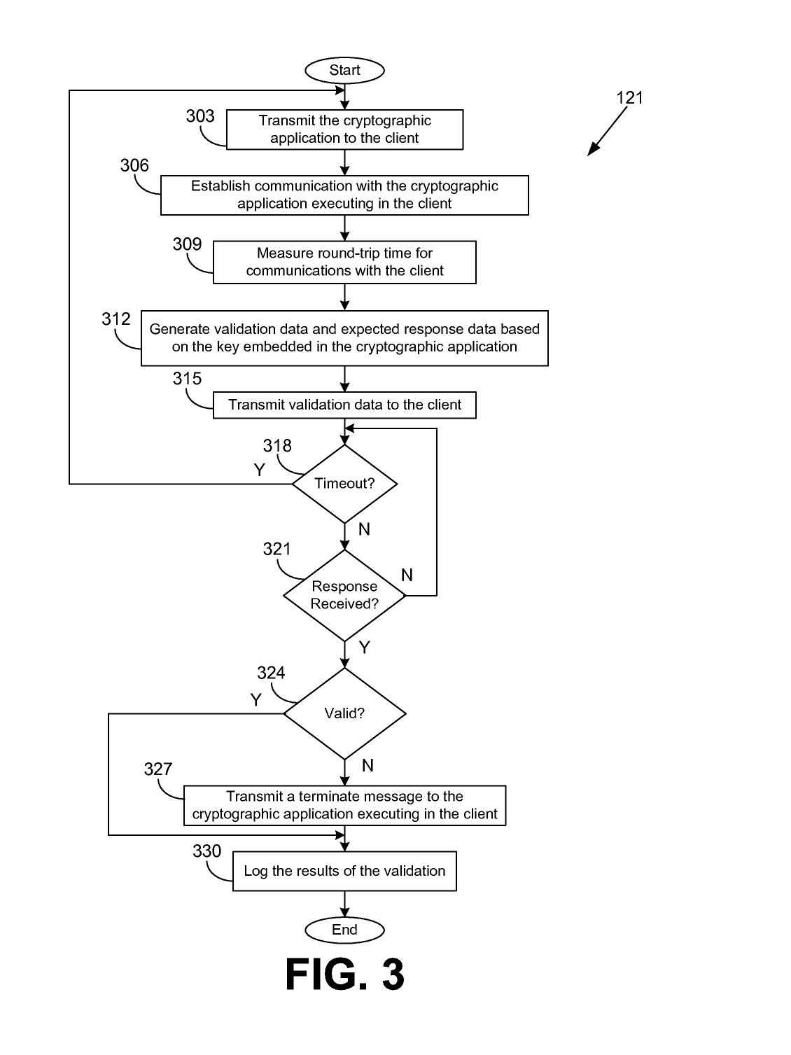

Turning now to FIG. 3, shown is a flowchart that provides another example of the operation of a portion of the dispatch service 121 according to various embodiments. It is understood that the flowchart of FIG. 3 provides merely an example of the many different types of functional arrangements that may be employed to implement the operation of the portion of the dispatch service 121 as described herein. As an alternative, the flowchart of FIG. 3 may be viewed as depicting an example of steps of a method implemented in the computing environment 103 (FIG. 1) according to one or more embodiments.

This portion of the execution of the cryptographic application 131 may be executed in response to a request from a client 106 (FIG. 1) to access and decrypt data provided to them using a handle 146 (FIG. 1). Beginning with block 303, the dispatch service 121 may transmit an instance of the cryptographic application 131 for execution in the client 106. The cryptographic application 131 executing in the client 106 may include an embedded application key 132a with which an extended validation of the cryptographic application 131 may be performed. Then, in block 306, the dispatch service 121 may begin communicating with the cryptographic application 131 executing in the client 106.

Next, in block 309, the dispatch service 121 estimating the round-trip time for communication between the computing environment 103 and the client 106. Continuing, in block 312, the dispatch service 121 may generate data to be operated upon by the cryptographic application 131 executing in the client 106 that will be used as the basis for validation (“validation data”). Additionally, the dispatch service 121 may generate the expected response data for a valid cryptographic application 131 based at least upon the embedded application key 132a.

Then, in block 315, the dispatch service 121 may transmit the validation data to the cryptographic application 131 executing in the client 106. Next, in block 318, the dispatch service 121 determines if a timeout has occurred for a response from the cryptographic application 131. If a response is not received from the cryptographic application 131 within the estimated round-trip time plus an acceptable tolerance (e.g. a timeout has occurred), then execution of the dispatch service 121 may return to block 303. For example, if the response is received earlier than the estimated round-trip time plus an acceptable tolerance, it may indicate that the connection between the client 106 and the computing environment 103 is subject to tampering, such as by a third party performing a man-in-the-middle attack. As another example, if the response is received later than the estimated round-trip time plus an acceptable tolerance, it may indicate that a timeout, such as one due to packet loss, has occurred. Alternatively, if a time out has not yet occurred execution of the dispatch service proceeds to block 321.

At block 321, the dispatch service 121 determines if any response is received from the cryptographic application. If not response is yet received, execution of the dispatch service returns to block 318. Alternatively, if a response has been received, execution of the dispatch service 121 proceeds to block 324. At block 324, the dispatch service 121 determines if the received response is as expected for a valid cryptographic application 131. As a non-limiting example, the data transmitted by the dispatch service 121 may include two different strings, a first string that is encrypted and the second string having no encryption applied. A valid cryptographic application 131 may be programmed to use the application key 132a to both decrypt the first string and to encrypt the second string, then transmit the two strings back to the dispatch service in a response. If the dispatch service 121 receives the response having the expected form, the dispatch service may examine the two strings in the response. If the cryptographic application 131 of the client 106 is valid and configured with the correct application key 132a, the data of the two strings will be as expected by the dispatch service 121.

If, in block 327, a response is received by the dispatch service 121 and the form of the response is not as expected, the dispatch service 121 may transmit a terminate instruction to the cryptographic application 131. Alternatively, if the response is as expected for a valid cryptographic application 131, in block 330 results of the validation may be logged. Thereafter, this portion of the execution of the dispatch service 121 may end as shown.

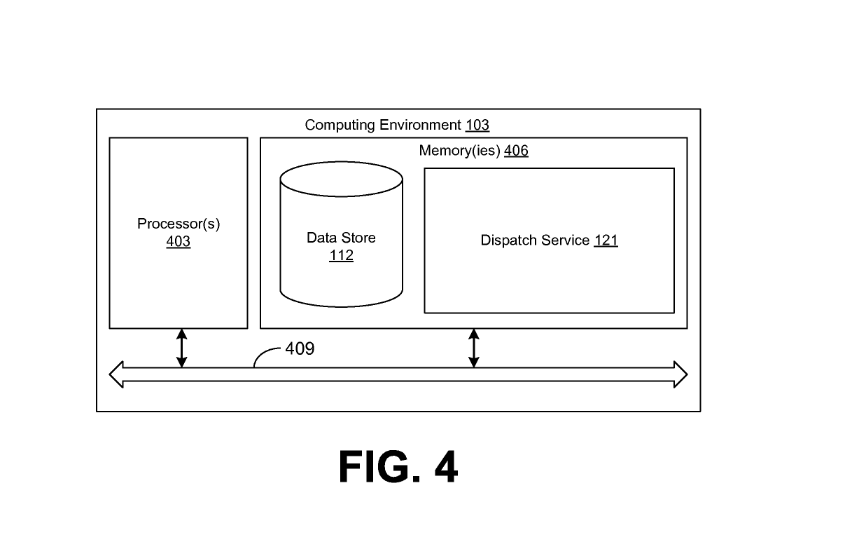

With reference to FIG. 4, shown is a schematic block diagram of the computing environment 103 according to an embodiment of the present disclosure. Each computing environment 103 includes at least one processor circuit, for example, having a processor 403 and a memory 406, both of which are coupled to a local interface 409. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are the dispatch service 121, and potentially other applications. Also stored in the memory 406 may be a data store 112 and other data. In addition, an operating system may be stored in the memory 406 and executable by the processor 403.

It is understood that there may be other applications that are stored in the memory 406 and are executable by the processor 403 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program, such as a virtual machine, to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and/or multiple processor cores and the memory 406 may represent multiple memories 406 that operate in parallel processing circuits, respectively. In such a case, the local interface 409 may be an appropriate network that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although the dispatch service 121, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 2 and 3 show the functionality and operation of an implementation of different portions of the dispatch service 121. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403 in a computer system or other system. The machine code may be converted from the source code, etc. If embodied in hardware, each block may represent a circuit or a number of interconnected circuits to implement the specified logical function(s).

Although the flowcharts of FIGS. 2 and 3 show a specific order of execution, it is understood that the order of execution may differ from that which is depicted. For example, the order of execution of two or more blocks may be scrambled relative to the order shown. Also, two or more blocks shown in succession in FIGS. 2 and 3 may be executed concurrently or with partial concurrence. Further, in some embodiments, one or more of the blocks shown in FIGS. 2 and 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the dispatch service 121, that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

I claim:

1. A system, comprising:
a computing device; and
an application executable in the computing device, the application comprising:
logic that transmits a cryptographic application to a client device;
logic that establishes a communication link with the transmitted cryptographic application, wherein the transmitted cryptographic application is executing in the client device subsequent to transmission;
logic that generates validation data and expected response data, wherein the validation data and the expected response data are based at least in part on a cryptographic key embedded in the transmitted cryptographic application executing in in the client device; and
logic that sends the validation data to the transmitted cryptographic application executing in the client device.

2. The system of claim 1, wherein the application further comprises:
logic that measures a round-trip time for a communication with the transmitted cryptographic application executing in the client device; and
logic that detects whether a response is received from the transmitted cryptographic application executing in the client device within a time window comprising the measured round-trip time plus a delay tolerance.

3. The system of claim 2, wherein the application further comprises logic that retransmits the cryptographic application to the client device in response to detecting that the response is not received.

4. The system of claim 2, wherein the application further comprises logic that retransmits the cryptographic application to the client device in response to detecting that the response is received outside of the time window.

5. The system of claim 2, wherein the application further comprises:
logic that determines whether the response is valid based at least in part on a comparison of the response with the expected response data; and
logic that logs whether the response is valid.

6. The system of claim 5, wherein the application further comprises logic that sends a termination message to the transmitted cryptographic application executing in the client device in response to a determination that the response is invalid.

7. They system of claim 1, wherein the application further comprises:
logic that generates an application key;
logic that embeds the application key within the cryptographic application; and
logic that obfuscates at least a portion of the cryptographic application.

8. A method, comprising:
transmitting, via a computing device, a cryptographic application to a client device;
establishing, via the computing device, a communication link with the transmitted cryptographic application, wherein the transmitted cryptographic application is executing in the client device subsequent to transmission;
generating, via the computing device, validation data and expected response data, wherein the validation data and the expected response data are based at least in part on a cryptographic key embedded in the transmitted cryptographic application executing in in the client device; and
sending, via the computing device, the validation data to the transmitted cryptographic application executing in the client device.

9. The method of claim 8, further comprising:
measuring, via the computing device, a round-trip time for a communication with the transmitted cryptographic application executing in the client device; and
detecting, via the computing device, whether a response is received from the transmitted cryptographic application executing in the client device within a time window comprising the measured round-trip time plus a delay tolerance.

10. The method of claim 9, further comprising retransmitting, via the computing device, the cryptographic application to the client device in response to detecting that the response is not received.

11. The method of claim 9, further comprising retransmitting, via the computing device, the cryptographic application to the client device in response to detecting that the response is received outside of the time window.

12. The method of claim 9, further comprising:
determining, via the computing device, whether the response is valid based at least in part on a comparison of the response with the expected response data; and
logging, via the computing device, a result of determining whether the response is valid.

13. The method of claim 12, further comprising transmitting, via the computing device, a termination message to the transmitted cryptographic application executing in the client device in response to determining that the response is invalid.

14. The method of claim 8, further comprising:
generating, via the computing device, an application key;
embedding, via the computing device, the application key within the cryptographic application; and
obfuscating, via the computing device, at least a portion of the cryptographic application.

15. A non-transitory computer readable medium including a program comprising:
code that transmits a cryptographic application to a client device;
code that establishes a communication link with the transmitted cryptographic application, wherein the transmitted cryptographic application is executing in the client device subsequent to transmission;
code that generates validation data and expected response data, wherein the validation data and the expected response data are based at least in part on a cryptographic key embedded in the transmitted cryptographic application executing in in the client device; and
code that sends the validation data to the transmitted cryptographic application executing in the client device.

16. The non-transitory computer readable medium of claim 15, the program further comprising code:
code that measures a round-trip time for a communication with the transmitted cryptographic application executing in the client device; and
code that detects whether a response is received from the transmitted cryptographic application executing in the client device within a time window comprising the measured round-trip time plus a delay tolerance.

17. The non-transitory computer readable medium of claim 16, the program further comprising code that retransmits the cryptographic application to the client device in response to detecting that the response is not received.

18. The non-transitory computer readable medium of claim 16, the program further comprising code that retransmits the cryptographic application to the client device in response to detecting that the response is received outside of the time window.

19. The non-transitory computer readable medium of claim 16, the program further comprising:
code that determines that the response is valid based at least in part on a comparison of the response with the expected response data; and
code that logs whether the response is valid.

20. The non-transitory computer readable medium of claim 19, the program further comprising code that sends a termination message to the transmitted cryptographic application executing in the client device in response to a determination that the response is invalid.
